(19) United States
(12) Patent Application Publication
(10) Pub. No.: US 2026/0317860 A1
(43) Pub. Date: Oct. 15, 2026

(54) METHOD FOR DIRECT LITHIUM EXTRACTION VIA A HIGH-CAPACITY SORBENT

(71) Applicant: UT-Battelle, LLC, Oak Ridge, TN (US)

(72) Inventors: Mariappan Parans Paranthaman, Knoxville, TN (US); Jayanthi Kumar, Knoxville, TN (US); Bruce A. Moyer, Oak Ridge, TN (US); Saurabh Prakash Pethe, Knoxville, TN (US)

(21) Appl. No.: 19/465,357

(22) Filed: Jan. 30, 2026

Related U.S. Application Data
(60) Provisional application No. 63/752,915, filed on Feb. 3, 2025.

(51) Int. Cl. C22B 26/12; C22B 3/22

(52) U.S. Cl. CPC C22B 26/12; C22B 3/22

(57) ABSTRACT

A method of extracting lithium from a feed solution containing lithium ions includes mixing amorphous aluminum hydroxide with the feed solution at a temperature of from 25 to 135° C. for a period of time, to obtain a product that includes a layered double hydroxide including the lithium ions. In a lithiation step, the sorbent is combined with the feed solution at a first temperature for a first period of time to obtain a first mixture that includes a first sorbate. The first sorbate is separated from the first mixture, and in a delithiation step, the first sorbate is combined with water at a second temperature for a second period of time to obtain a second mixture that includes a delithiated sorbate. The delithiated sorbate is separated from the second mixture to obtain a product solution that includes lithium released from the first sorbate upon treatment with water.

### CROSS-REFERENCE TO RELATED APPLICATIONS

This application claims the benefit of U.S. Provisional Application No. 63/752,915, filed Feb. 3, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of extracting lithium from a solution using a sorbent.

### BACKGROUND OF THE INVENTION

The demand for lithium continues to rise due to the increased usage of rechargeable lithium-ion batteries (LIB) in electric vehicles, smartphones, and other portable electronics. Conventional lithium production such as evaporation ponds, mineral processing, and solvent extraction suffers from long residence times, high water and energy consumption, and environmental burdens associated with large land footprints and chemical usage. To alleviate the potential risk of undersupply, lithium can be extracted from raw sources containing minerals and brines and/or from recycled batteries.

Direct lithium extraction technologies have emerged as promising alternatives to traditional processes due to their potential for high selectivity, lower chemical consumption, and reduced environmental impact. Among various direct lithium extraction approaches, sorbent-based systems are particularly attractive because they enable selective lithium uptake from complex brines. However, conventional sorbents often suffer from high cost, structural instability, slow kinetics, or poor selectivity in the presence of competing ions such as Na⁺ and Mg²⁺. Hence, a need exists to develop an improved direct lithium extraction process from various sources of lithium-containing solutions. Also, in order to meet increasing lithium demand, a need exists for efficient extraction methods that are environmentally friendly and/or economically viable.

### SUMMARY OF THE INVENTION

A method of extracting lithium from an aqueous feed solution containing lithium ions is provided. The method includes mixing amorphous aluminum hydroxide (A-Al(OH)₃) with the feed solution at a temperature in a range of from 25 to 135° C. for a period of time, to obtain a product that includes a layered double hydroxide (LDH) including the lithium ions.

In various embodiments, the method includes providing a sorbent that includes amorphous aluminum hydroxide (A-Al(OH)₃). The method further includes performing a lithiation step that includes combining the sorbent with the feed solution at a first temperature for a first period of time to obtain a first mixture that includes a first sorbate. The term sorbate refers to the sorbent that has been loaded with lithium in lithiation steps. The method further includes separating the first sorbate from the first mixture. The method further includes performing a delithiation step that includes combining the first sorbate with water at a second temperature for a second period of time to obtain a second mixture that includes a delithiated sorbate, and separating the delithiated sorbate from the second mixture to obtain a product solution that includes lithium released from the first sorbate upon treatment with water.

In specific embodiments, the first temperature is in a range of from 25 to 135° C.

In particular embodiments, the first temperature is in a range of from 40 to 60° C.

In specific embodiments, the first temperature is in a range of from 25 to 60° C., and in the lithiation step the combined amorphous aluminum hydroxide and feed solution are stirred for the first period of time.

In specific embodiments, the first temperature is in a range of from 60 to 135° C., and in the lithiation step the combined amorphous aluminum hydroxide and feed solution are mixed in a reaction vessel such as a tank fitted with a reflux condenser or autoclave for the first period of time.

In specific embodiments, the first period of time is in a range of from 5 minutes to 18 hours.

In specific embodiments, the first sorbate includes a layered double hydroxide (LDH), the layered double hydroxide including Al³⁺ and Li⁺ cations and further including anions from the feed solution.

In specific embodiments, the second temperature is in a range of from 92 to 98° C.

In specific embodiments, the second period of time is in a range of from 2 to 10 hours.

In particular embodiments, the second period of time is in a range of from 2 to 4 hours.

In specific embodiments, a ratio of sorbent to feed solution in the lithiation step is approximately 1 g to 10 mL.

In specific embodiments, a lithium capacity of the lithiation step is at least 10 mg lithium per 1 g sorbent.

In particular embodiments, the lithium capacity is at least 20 mg/g.

In specific embodiments, the lithiation step is performed in either a single stage or a plurality of stages, and the delithiation step is performed in either a single stage or a plurality of stages.

In particular embodiments, i) the lithiation step is performed in two or more stages, and a sorbent stream and a feed solution stream are arranged in cross-flow or counter-current flow; ii) the delithiation step is performed in two or more stages, and a sorbate stream and a water stream are arranged in cross-flow or counter-current flow; or iii) both i) and ii).

In specific embodiments, the method further includes a sorbent regeneration step that includes dissolving the delithiated sorbate in nitric acid to obtain a regeneration mixture, and adding sodium hydroxide and ammonium hydroxide to the regeneration mixture at a pH of approximately 6 or less to form amorphous aluminum hydroxide.

In specific embodiments, the feed solution includes at least one of chloride ions, sulfate ions, nitrate ions, carbonate ions, and hydroxide ions.

In specific embodiments, the feed solution is obtained from recycled lithium-ion battery material, a source of raw minerals, mine tailings, or a chemical process/oil and gas drilling stream.

In specific embodiments, the feed solution is a brine.

These and other features of the invention will be more fully understood and appreciated by reference to the description of the embodiments and the drawings.

### BRIEF DESCRIPTION OF THE DRAWINGS

FIG. 1 is a schematic illustration of a method of extracting lithium from a solution that contains lithium ions in accordance with embodiments of the disclosure;

FIG. 2 is a schematic illustration of a two-stage lithiation step arranged in a cross-flow configuration in accordance with some embodiments of the disclosure;

FIG. 3 is a schematic illustration of a two-stage lithiation step arranged in a counter-current flow configuration in accordance with other embodiments of the disclosure;

FIG. 4 is a schematic illustration of a two-stage delithiation step arranged in a cross-flow configuration in accordance with yet other embodiments of the disclosure;

FIG. 5 is a schematic illustration of a two-stage delithiation step arranged in a counter-current flow configuration in accordance with yet other embodiments of the disclosure;

FIG. 6 is a graph of lithium uptake as a function of reaction temperature for a single-stage lithiation step in accordance with some embodiments of the disclosure;

FIG. 7 is a graph of Powder X-ray Diffractometry (PXRD) patterns for bayerite and layered double hydroxide sorbates (A-Cl-LDH) at various reaction temperature in accordance with some embodiments of the disclosure;

FIG. 8 is a graph of lithium uptake capacity as a function of time at a temperature of 40° C. for a single-stage lithiation step in accordance with some embodiments of the disclosure;

FIG. 9 is a graph of lithium release as a function of time at a temperature of 95° C. for a single-stage delithiation step in accordance with some embodiments of the disclosure;

FIG. 10 is a graph of PXRD patterns for commercial (virgin) amorphous Al(OH)₃; delithiated Al(OH)₃ LDH, and amorphous Al(OH)₃; regenerated in accordance with some embodiments of the disclosure; and

FIG. 11 is a graph of Fourier Transform Infrared Spectroscopy (FTIR) spectra for the commercial (virgin) amorphous Al(OH)₃; delithiated Al(OH)₃ LDH, and regenerated amorphous Al(OH)₃.

### DETAILED DESCRIPTION OF THE CURRENT EMBODIMENTS

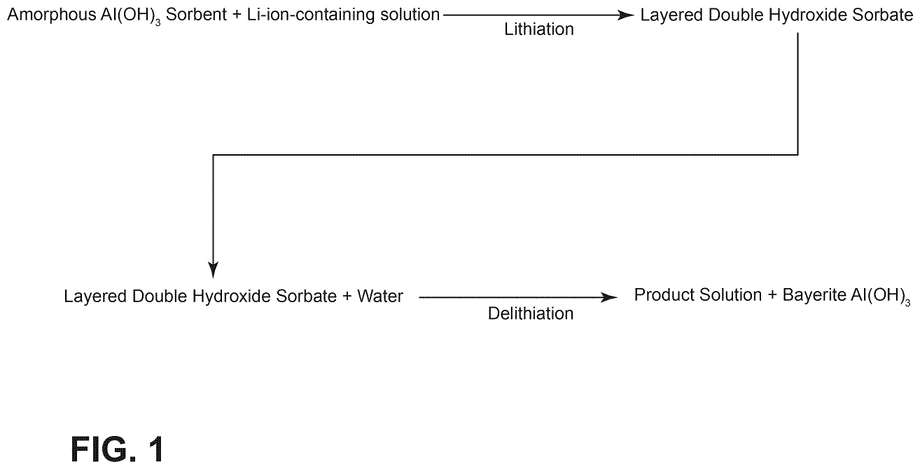

As discussed herein, the current embodiments relate to a method of extracting lithium from a feed solution using a high-capacity sorbent. As generally illustrated in FIG. 1, the method includes a lithiation step that involves combining an amorphous aluminum hydroxide (A-Al(OH)₃) sorbent with the feed solution to produce a layered double hydroxide sorbate that includes lithium from the feed solution. The method also includes a delithiation step that involves combining the layered double hydroxide sorbate obtained from the lithiation step with water to obtain a product solution that includes lithium released from the first sorbate upon treatment with the water. Each step is separately discussed in detail below.

The method first includes the lithiation step. In the lithiation step, the amorphous aluminum hydroxide (A-Al(OH)₃) sorbent is introduced to the feed solution by mixing or otherwise combining the sorbent with the feed solution. The amorphous aluminum hydroxide sorbent may be virgin material that is commercially obtained or may be regenerated amorphous aluminum hydroxide that is cyclically produced by the method disclosed herein as described in further detail below. The feed solution includes one or more metal cations including at least lithium ions. The feed solution may also include other cations such as, but not limited to, sodium ions, potassium ions, magnesium ions, and/or calcium ions. The feed solution also includes one or more types of anions, such as, but not limited to, chloride ions, sulfate ions, nitrate ions, carbonate ions, and/or hydroxide ions. In certain exemplary embodiments, the feed solution may be obtained directly or indirectly from recycled lithium-ion battery material, a source of raw minerals, mine tailings, or a chemical process/oil and gas drilling stream. In various embodiments, the feed solution is a brine. As such, the feed solution is preferably an aqueous solution in which the solvent is water.

The amorphous aluminum hydroxide sorbent and feed solution may be mixed in a stirred-tank, and as such the lithiation may be performed as a batch operation. Alternatively, the feed solution may be passed through the amorphous aluminum hydroxide sorbent in a column, and the lithiation may be performed as a continuous operation until the sorbent is loaded with lithium to a desired degree. However, it should be understood that these are exemplary embodiments and the amorphous aluminum hydroxide sorbent and feed solution may be combined in a reaction vessel other than a stirred tank or column.

Once combined, the lithiation reaction between the amorphous aluminum hydroxide sorbent and feed solution is performed at a first temperature for a first period of time to obtain a first mixture that includes a first sorbate and the remaining solution of cations and anions in the feed solution solvent. The first temperature may be in a range of from approximately 25 to 135° C., optionally from 25 to 60° C., optionally from 30 to 60° C., optionally from 35 to 60° C., optionally from 40 to 60° C., optionally from 45 to 60° C., optionally from 50 to 60° C., optionally from 55 to 60° C., optionally from 60 to 135° C., optionally from 65 to 135° C., optionally from 70 to 135° C., optionally from 75 to 135° C., optionally from 80 to 135° C., optionally from 85 to 135° C., optionally from 90 to 135° C., optionally from 95 to 135° C., optionally from 100 to 135° C., optionally from 105 to 135° C., optionally from 110 to 135° C., optionally from 115 to 135° C., optionally from 120 to 135° C., optionally from 125 to 135° C., optionally from 130 to 135° C., optionally from 25 to 95° C., optionally from 30 to 95° C., optionally from 35 to 95° C., optionally from 40 to 95° C., optionally from 45 to 95° C., optionally from 50 to 95° C., optionally from 55 to 95° C., optionally from 60 to 95° C., optionally from 65 to 95° C., optionally from 70 to 95° C., optionally from 75 to 95° C., optionally from 80 to 95° C., optionally from 85 to 95° C., optionally from 90 to 95° C. The first period of time may be at least approximately 5 minutes, optionally at least 15 minutes, optionally at least 30 minutes, optionally at least 45 minutes, optionally at least 1 hour, optionally at least 2 hours, optionally at least 3 hours, optionally at least 4 hours, optionally at least 5 hours, optionally at least 6 hours, optionally at least 7 hours, optionally at least 8 hours, optionally at least 9 hours, optionally at least 10 hours, optionally at least 11 hours, optionally at least 12 hours, optionally at least 13 hours, optionally at least 14 hours, optionally at least 15 hours, optionally at least 16 hours, optionally at least 17 hours, optionally at least 18 hours, optionally in a range of from 5 minutes to 18 hours, optionally from 15 minutes to 18 hours, optionally from 30 minutes to 18 hours, optionally from 45 minutes to 18 hours, optionally from 1 to 18 hours, optionally from 2 to 18 hours, optionally from 3 to 18 hours, optionally from 4 to 18 hours, optionally from 5 to 18 hours, optionally from 6 to 18 hours, optionally from 7 to 18 hours, optionally from 8 to 18 hours, optionally from 9 to 18 hours, optionally from 10 to 18 hours, optionally from 11 to 18 hours, optionally from 12 to 18 hours, optionally from 13 to 18 hours, optionally from 14 to 18 hours, optionally from 15 to 18 hours, optionally from 16 to 18 hours, optionally from 17 to 18 hours, optionally from 1 to 17 hours, optionally from 1 to 16 hours, optionally from 1 to 15 hours, optionally from 1 to 14 hours, optionally from 1 to 13 hours, optionally from 1 to 12 hours, optionally from 1 to 11 hours, optionally from 1 to 10 hours, optionally from 1 to 9 hours, optionally from 1 to 8 hours, optionally from 1 to 7 hours, optionally from 1 to 6 hours, optionally from 1 to 5 hours, optionally from 1 to 4 hours, optionally from 1 to 3 hours, optionally from 1 to 2 hours.

In certain embodiments in which the first temperature is in the range of 25 to 60° C., the combined amorphous aluminum hydroxide sorbent and feed solution may be stirred for the first period of time such as in a stirred tank. In other certain embodiments in which the first temperature is in a range of from 60 to 135° C., the combined amorphous aluminum hydroxide sorbent and feed solution may be mixed in a reaction vessel fitted if needed with a reflux condenser or in an autoclave for the first period of time. However, it should be understood that the combined amorphous aluminum hydroxide sorbent and feed solution may be reacted in other reaction vessels, and that, for example, the combined amorphous aluminum hydroxide and feed solution may be mixed in a stirred tank at a temperature above 60° C.

In various embodiments, the ratio of amorphous aluminum hydroxide sorbent to feed solution in the lithiation step is in a range of from approximately 1 g of sorbent to 1 mL of feed solution to 1 g of sorbent to 50 mL of feed solution (i.e., a range of from 1 g: 1 mL to 1 g: 50 mL), optionally from 1 g: 5 mL to 1 g: 25 mL, optionally from 1 g: 5 mL to 1 g: 15 mL, optionally from 1 g: 10 mL to 1 g: 50 mL, optionally from 1 g: 10 mL to 1 g: 40 mL, optionally from 1 g: 10 mL to 1 g: 30 mL, optionally from 1 g: 10 mL to 1 g: 20 mL. In certain embodiments, the ratio of amorphous aluminum hydroxide sorbent to feed solution in the lithiation step is approximately 1 g of sorbent to 10 mL of feed solution (i.e., 1 g: 10 mL). Also, in various embodiments the lithium capacity of the lithiation step is at least approximately 5 mg of lithium per 1 g of sorbent, optionally at least 10 mg lithium per 1 g sorbent optionally, at least 15 mg lithium per 1 g sorbent, optionally at least 20 mg lithium per 1 g sorbent, optionally at least 25 mg lithium per 1 g sorbent, optionally at least 30 mg lithium per 1 g sorbent, optionally in a range of from 10 mg lithium per 1 g sorbent to 35 mg lithium per 1 g sorbent, optionally in a range of from 15 mg lithium per 1 g sorbent to 35 mg lithium per 1 g sorbent, optionally in a range of from 20 mg lithium per 1 g sorbent to 35 mg lithium per 1 g sorbent, optionally in a range of from 25 mg lithium per 1 g sorbent to 35 mg lithium per 1 g sorbent, optionally in a range of from 30 mg lithium per 1 g sorbent to 35 mg lithium per 1 g sorbent, optionally in a range of from 10 mg lithium per 1 g sorbent to 30 mg lithium per 1 g sorbent, optionally in a range of from 10 mg lithium per 1 g sorbent to 25 mg lithium per 1 g sorbent, optionally in a range of from 10 mg lithium per 1 g sorbent to 20 mg lithium per 1 g sorbent, optionally in a range of from 10 mg lithium per 1 g sorbent to 15 mg lithium per 1 g sorbent.

The first sorbate obtained from the lithiation step is a layered double hydroxide (LDH) that includes Al³⁺ cations from the amorphous aluminum hydroxide and Li⁺ cations from the feed solution. The layered double hydroxide also includes one or more types of anions from the feed solution, such as, for example, chloride ions, sulfate ions, nitrate ions, carbonate ions, and/or hydroxide ions. Layered double hydroxides have a layer sequence that can be represented by the formula [AcB Z AcB]ₙ in which A and B are layers of hydroxide (OH⁻) anions, c are positively charged layers of metal cations (e.g., lithium ions and aluminum ions), Z is an interlayer filled by water and one or more types of anions (e.g., chloride ions, sulfate ions, nitrate ions, carbonate ions) to balance the charge of the metal cations, and n is the number of repeating units.

The first sorbate is separated from the first mixture by any known separation process, such but not limited to, centrifugation/decantation, filtration, sedimentation/decantation, or any other suitable solid-liquid separation method. The first sorbate is thusly removed from the liquid solvent of the first mixture and subsequently may be rinsed and/or dried.

The method further includes the delithiation step. In the delithiation step, the first sorbate obtained from the lithiation step is mixed with or otherwise combined with water, which may be distilled water, deionized water, or alternatively process water or water from another source. The water may contain low levels of impurities or other additives. Similar to the lithiation step, the first sorbate and water may be mixed in a stirred-tank and as such the delithiation may be performed as a batch operation. Alternatively, the first sorbate and water may be combined in a column and the delithiation may be performed as a continuous operation. However, it should be understood that these are exemplary embodiments and the first sorbate and water may be combined in a reaction vessel other than a stirred tank or column.

Once combined, the delithiation reaction between the first sorbate and water is performed at a second temperature for a second period of time to obtain a second mixture that includes a delithiated sorbate which may include trace amounts of lithium. The second temperature is in a range of from approximately 90 to 100° C., optionally from 91 to 99° C., optionally from 92 to 98° C., optionally from 93 to 97° C., optionally from 94 to 96° C., optionally from 90 to 95° C., optionally from 91 to 95° C., optionally from 92 to 95° C., optionally from 93 to 95° C., optionally from 94 to 95° C., optionally from 95 to 100° C., optionally from 95 to 99° C., optionally from 95 to 98° C., optionally from 95 to 97° C., optionally from 95 to 96° C., optionally approximately 95° C. The second period of time is at least approximately 1 hour, optionally at least 2 hours, optionally at least 3 hours, optionally at least 4 hours, optionally in a range of from 1 to 10 hours, optionally from 2 to 10 hours, optionally from 3 to 10 hours, optionally from 4 to 10 hours, optionally from 5 to 10 hours, optionally from 6 to 10 hours, optionally from 7 to 10 hours, optionally from 8 to 10 hours, optionally from 9 to 10 hours, optionally from 1 to 5 hours, optionally from 1 to 4 hours, optionally from 1 to 3 hours, optionally from 2 to 5 hours, optionally from 2 to 4 hours, optionally from 3 to 5 hours.

In the delithiation step, lithium ions are released (leached) from the first sorbate and are taken up by (dissolved in solution in) the water. The anions present in the first sorbate from the lithiation step are also released from the first sorbate into the water. The release of lithium cations and corresponding anions from the first sorbate leaves aluminum hydroxide in the second mixture, mainly or completely in the form of bayerite aluminum hydroxide (B—Al(OH)₃. As such, the second mixture mainly includes an aqueous solution of lithium ions and corresponding cations, and bayerite aluminum hydroxide. If not all of the lithium is released from the first sorbate, then the second mixture also includes some of the first sorbate.

Next, the solid components of the second mixture are separated by any known separation process, such as but not limited to, centrifugation/decantation, filtration, sedimentation/decantation, or any other suitable solid-liquid separation method, to obtain a product solution that includes the lithium released from the first sorbate upon treatment with water. The lithium present in the product solution may be used directly in downstream processes, or the lithium may be removed/recovered from the product solution by any known, suitable separation method. The separation also results in a solids component including the bayerite aluminum hydroxide from the delithiation of the layered double hydroxide. The solids component may include partially delithiated sorbate, in which case the solids can be subjected to further delithiation stages. The solids component subsequently may be rinsed and/or dried. The bayerite aluminum hydroxide may be kept and returned to the amorphous phase as amorphous aluminum hydroxide. Therefore, the method may further include a sorbent regeneration step that includes dissolving the delithiated sorbate in nitric acid or hydrochloric acid to obtain a regeneration mixture, and adding sodium hydroxide and ammonium hydroxide to the regeneration mixture at a pH of approximately 6 or less to form amorphous aluminum hydroxide. The amorphous aluminum hydroxide thusly obtained may be utilized in a further lithiation step, and the sorbent of the process is cyclically converted to a layered double hydroxide in the lithiation step, and then to bayerite aluminum hydroxide in the delithiation step, and returned to amorphous aluminum hydroxide in the regeneration step.

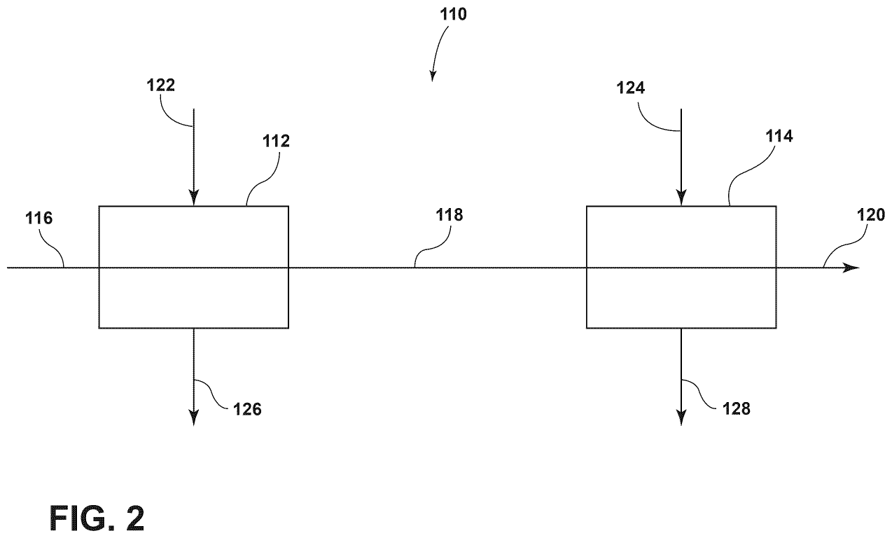

In some embodiments, the lithiation step is performed in a single stage. Likewise, the delithiation step may also be performed in a single stage. However, in other embodiments, the lithiation step may be performed in a multi-stage arrangement including a plurality of (two or more) stages. Likewise, the delithiation step may be performed in a multi-stage arrangement including a plurality of (two or more) stages. As such, both the lithiation step and the delithiation step may be performed each in a single stage, or alternatively the lithiation step may be performed in multiple stages while the delithiation step is performed in a single stage, or alternatively the lithiation step may be performed in a single stage with the delithiation step is performed in multiple stages, or alternatively both the lithiation step and the delithiation step may be both performed in multiple stages. With reference to FIGS. 2-5, in a multi-stage configuration, each of the lithiation step and the delithiation step may be performed with the process streams arranged in, for example, in a cross-flow configuration or a counter-current flow configuration.

Turning first to FIG. 2, by way of example the lithiation step 110 may include two stages including a first stage 112 and a second stage 114 that are arranged in a cross-flow configuration. Each stage 112, 114 is performed for the period of time and at the temperature specified for the lithiation step above. The feed solution 116, e.g. a brine solution, enters the first stage 112, the remaining brine solution after lithiation in the first stage 112 exits the first stage 112 and becomes the feed solution 118 for the second stage. The feed solution 118 enters the second stage 114 and the remaining brine solution exits the second stage 114 as output solution 120. Fresh sorbent 122 is fed to the first stage 112, and separately fresh sorbent 124 is likewise fed to the second stage 114. Sorbate 126 including a layered double hydroxide including lithium is produced by the first stage 112 as an output, and likewise sorbate 128 including a layered double hydroxide including lithium is separately produced by the second stage 114 as an output. In this arrangement, the concentration of lithium in the feed solution 116 will be greater than the concentration of lithium in the feed solution 118, and as such the amount of lithium in the sorbate 126 will be more than the amount of lithium in the sorbate 128. It should also be understood that the feeds may be switched, such that fresh feed solution is separately fed to the first and second stages, while the sorbent/sorbate and sequentially fed to the first stage followed by the second stage.

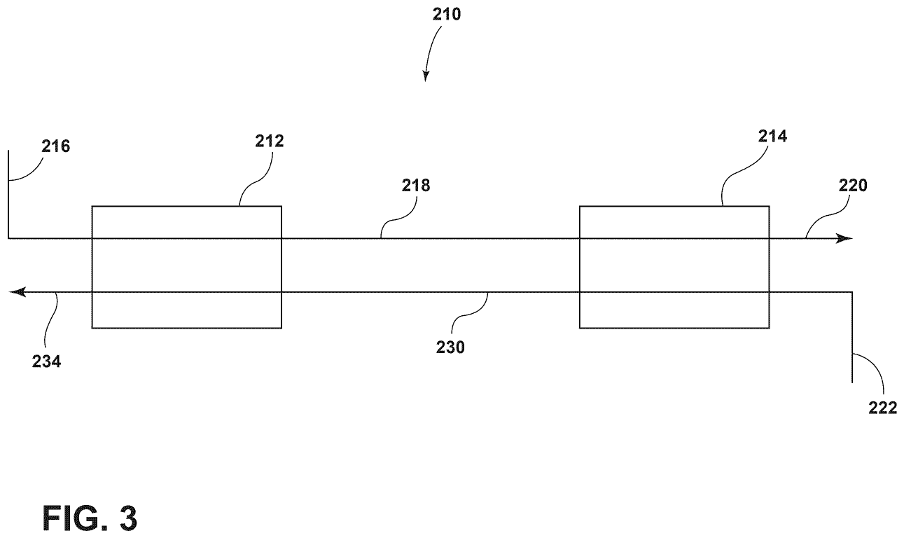

Turning next to FIG. 3, by way of example the lithiation step 210 may include a first stage 212 and a second stage 214 that are alternatively arranged in a counter-current flow configuration. Each stage 212, 214 is performed for the period of time and at the temperature specified for the lithiation step above. The feed solution 216, e.g. a brine solution, enters the first stage 212, further depleted brine solution after lithiation in the first stage 212 exits the first stage 212 and becomes the feed solution 218 for the second stage. The feed solution 218 enters the second stage 214 and further depleted brine solution exits the second stage 214 as output solution 220. Concurrently, fresh sorbent 222 is fed to the second stage 214, sorbate 230 exits the second stage 214 and is fed to the first stage 212, and sorbate 234 exits the first stage 212. In this arrangement, the concentration of lithium in the feed solution 216 will be greater than the concentration of lithium in the feed solution 218. Likewise, the concentration of lithium in the product solution 220 will be less than the concentration of lithium in the feed solution 218. Also, the amount of lithium in the sorbate 234 will be greater than the amount of lithium in the sorbate 230.

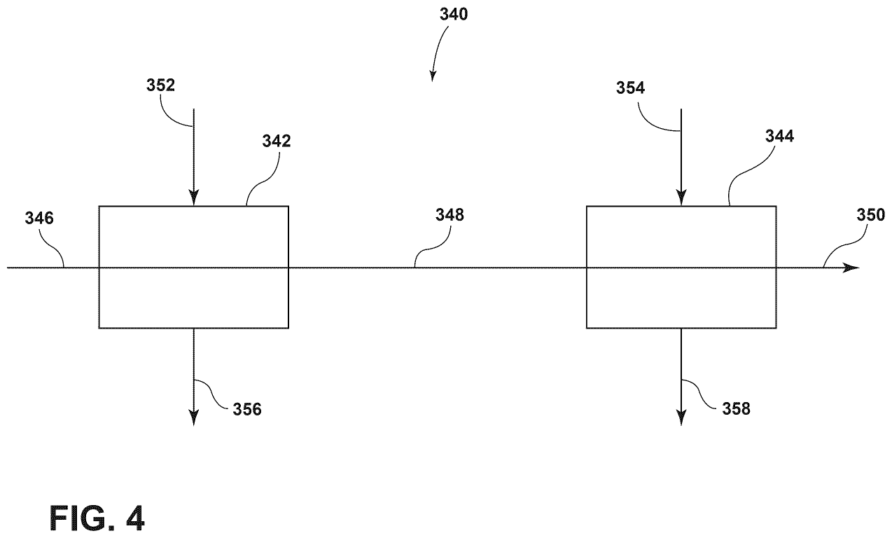

Turning next to FIG. 4, by way of example the delithiation step 340 may include two stages including a first stage 342 and a second stage 344 that are arranged in a cross-flow configuration. Each stage 342, 344 is performed for the period of time and at the temperature specified for the delithiation step above. Sorbate 346 loaded with lithium from either the cross-flow or counter-current lithiation steps enters the first stage 342, the treated sorbate after delithiation in the first stage 342 exits the first stage 342 and becomes the sorbate feed 348 for the second stage 344. The sorbate 348 enters the second stage 344, and the treated sorbate exits the second stage 344 as output sorbate 350. Fresh water 352 is fed to the first stage 342, and separately fresh water 354 is likewise fed to the second stage 344. An aqueous product solution 356 including lithium ions released from the sorbate 346 is produced by the first stage 342 as an output, and likewise an aqueous product solution 358 including lithium ions released from the sorbate 348 is separately produced by the second stage 344 as an output. In this arrangement, the amount of lithium in the sorbate 346 will be greater than the amount of lithium in the sorbate 348, and the amount of lithium in the sorbate 348 will be greater than the amount of lithium in the sorbate 350. The concentration of lithium in the product solution 356 exiting the first stage 342 will be greater than the concentration of lithium in the product solution 358 exiting the second stage 344.

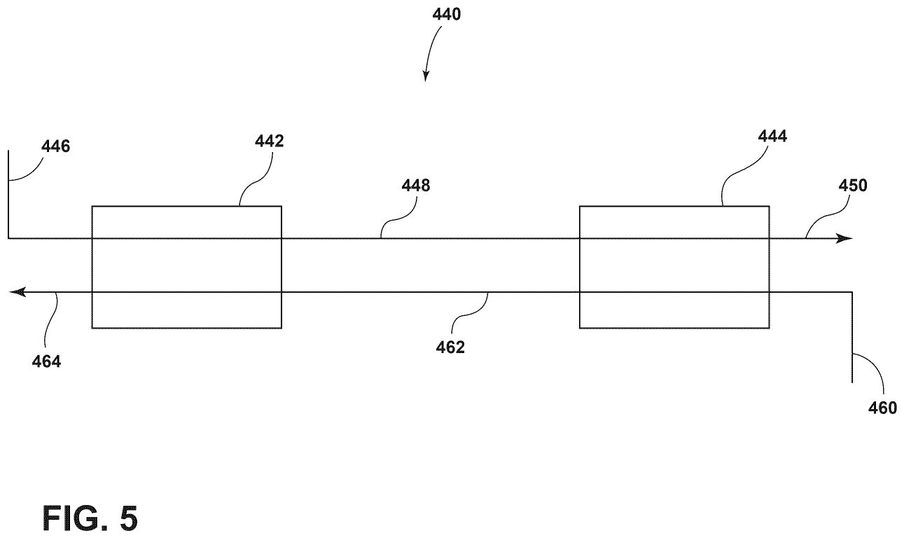

Turning next to FIG. 5, by way of example the delithiation step 440 may include two stages including a first stage 442 and a second stage 444 that are alternatively arranged in a counter-current flow configuration. Each stage 442, 444 is performed for the period of time and at the temperature specified for the delithiation step above. Sorbate 446 from a lithiation step enters the first stage 442, the treated sorbate after delithiation in the first stage 442 exits the first stage 442 and becomes the sorbate feed 448 for the second stage 444. The sorbate 448 enters the second stage 444 and the treated sorbate solution exits the second stage 444 as output delithiated sorbate 450. Concurrently, fresh water 460 is fed to the second stage 444, an intermediate aqueous solution 462 including water and lithium ions released from the sorbate 448 exits the second stage 444 and is fed to the first stage 442, and the product solution 464 including water and lithium released from the sorbate 446 exits the first stage 442. In this arrangement, the amount of lithium in the sorbate 446 will be greater than the amount of lithium in the sorbate 448, and the amount of lithium in sorbate 448 will be greater than the amount of lithium in the delithiated sorbate 450. Also, the concentration of lithium in the product solution 464 will be greater than the amount of lithium in the intermediate solution 462.

### EXAMPLES

The present method is further described in connection with the following laboratory examples, which are intended to be non-limiting.

Two separate cases were studied. In Case 1, a first brine-simulating solution was prepared using LiCl in water. In Case 2, a second brine-simulating solution was prepared with a mixture of LiCl, NaCl, and KCl in water. For Case 1, the pH and lithium concentration were 5.75 and 2220 ppm, respectively. For Case 2, the solution contained 468 ppm of lithium, 4810 ppm of sodium, and 4470 ppm of potassium.

Turning first to Case 1, to maximize lithium uptake in the lithiation step, twice the stoichiometric amount of A-Al(OH)₃ sorbent was used. Particularly, 2.0 g of A-Al(OH)₃ was mixed with 20 mL of the first brine-simulating solution and placed in a screw-capped bottle (for room temperature (RT), 40° C., and 60° C. examples) or a round-bottom flask with a reflux condenser attached to a chiller (for 80° C. and 95° C. examples). The mixture was stirred continuously at these various temperatures for up to 18 hours. The pH was measured both before and after the lithiation process. Following centrifugation of the precipitate, the supernatant solution was decanted, and the solid was dried in an oven at 60° C. The solid is referred to herein as A-Cl-LDH corresponding to the chloride form of LDH synthesized using A-Al(OH)₃.

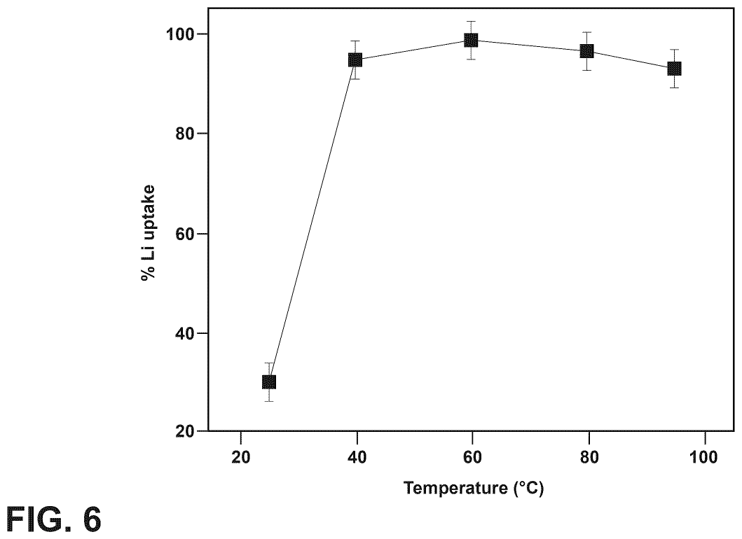

The impact of temperature on lithium uptake from the first brine-simulating solution using A-Al(OH)₃ sorbent is shown in FIG. 6 as well as Table 1 below. The theoretical lithium loading capacity (loading of Li in a solid LDH sample) per gram of the sorbent was calculated to be 6.41 meq/g, with meq being calculated as (mg×valence)/molecular weight, wherein the valence of Li is 1 and the molecular weight is 6.941 g/mol. At room temperature (RT), the lithium uptake was 30.3%, with a loading of 6.72 mg/g (0.97 meq/g), which corresponds to a 15% theoretical capacity. At 40° C., the uptake dramatically increased to 94.4%, achieving 20.96 mg/g (3.02 meq/g) loading which corresponds to 47% theoretical capacity. Further increasing the temperature to the range of 60° C. to 95° C. showed similar lithium uptake percentages of 98.4%, 96.1%, and 92.7%, respectively, with corresponding loadings and theoretical capacity between 46 and 49%. These results indicate that increasing the temperature above room temperature enhances lithium uptake and loading, with the highest uptake observed at 60° C. At the same time, above 40° C. there was no major difference in the percentage uptake of lithium or loading.

TABLE 1
Lithium Uptake Percentage and Loading by A-Al(OH)₃ for Case 1.

| | | | Concentration | | | |
|---|---|---|---|---|---|---|
| | | | of Li in the | | | |
| | pH before | pH after | decant | % | Loading | Loading |
| Temperature | contact | uptake | (μg/mL)* | uptake | (mg Li/g) | (meq Li/g) |
| RT | 7.60 | 6.45 | 1550 | 30.3 | 6.72 | 0.970 |
| 40° C. | 7.62 | 4.80 | 123 | 94.4 | 21.0 | 3.02 |
| 60° C. | 7.70 | 4.58 | 34.8 | 98.4 | 21.8 | 3.15 |
| 80° C. | 7.68 | 4.99 | 86.4 | 96.1 | 21.3 | 3.07 |
| 95° C. | 7.73 | 5.09 | 163 | 92.7 | 20.6 | 2.96 |

*±5% uncertainty

The uptake shown in Table 1 reflects loading vs capacity. The latter would be expected to be twice the measured loading because the stoichiometric amount of A-Al(OH)₃ used in Case 1 was twice that required to achieve the ideal A-LDH stoichiometry LiCl·Al₂ (OH)_{6·x}H₂O. Also, capacity would properly be the maximum level of loading that would be achieved for the sorbent in equilibrium with the feed solution at its initial Li concentration. Capacity thus would reflect the loading of the material in a column, for example, driven to full breakthrough. In batch tests, the capacity would be obtainable by successive contacts of loaded sorbent with fresh solution until no more Li is sorbed, which was not done in these examples.

The dried, loaded solids isolated by centrifugation from the sorption of Li from first brine-simulating solution using A-Al(OH)₃ were subjected to analysis upon dissolution in nitric acid. Inductively Coupled Plasma-Optical Emission Spectrometry (ICP-OES) results illustrating the lithium content in the solid sorbents at various temperatures are shown in Table 2 below. At room temperature (RT), the lithium content was 1.19 meq/g. When the temperature was increased to 40° C., the lithium loading significantly rose to 3.12 meq/g. This loading remained consistent at 60° C. with 3.12 meq/g and showed only slight variation at higher temperatures, with 2.90 meq/g at 80° C. and 2.62 meq/g at 95° C. This data indicated that the lithium loading in the solid sorbent stabilized at 40° C., and further temperature increases did not lead to substantial improvements. Consequently, 40° C. was considered optimal for achieving high lithium loading with balanced energy requirements and was selected as the temperature for further study.

TABLE 2
ICP-OES Results of the Sorbate Solids for Case 1.

| Temp. | Al (μg/g)* | Li (μg/g)* | (mg Li/g sorbent) | (meq Li/g sorbent) |
|---|---|---|---|---|
| RT | 252000 | 6000 | 8.25 | 1.19 |
| 40 °C | 236000 | 14800 | 21.6 | 3.12 |
| 60 °C | 245000 | 154 | 21.7 | 3.12 |
| 80 °C | 259000 | 15000 | 20.1 | 2.90 |
| 95 °C | 267000 | 14100 | 18.2 | 2.62 |

*±5% uncertainty

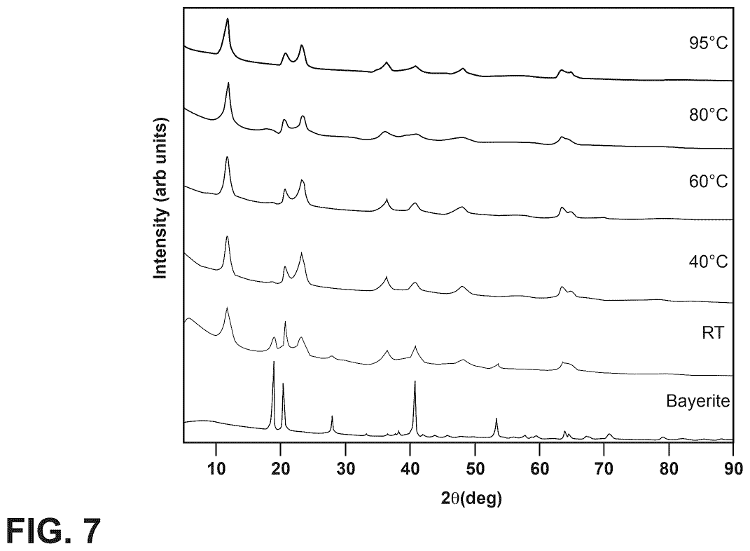

Powder X-ray Diffractometry (PXRD) measurements taken for the A-Cl-LDHs formed at the different temperatures are shown in FIG. 7. At room temperature (RT), the presence of a bayerite phase was observed along with the LDH phase. In contrast, the PXRD patterns for the A-Cl-LDHs formed at temperatures ranging from 40° C. to 95° C. displayed a single phase corresponding to chloride LDH. This indicated that temperatures above room temperature favor the formation of a pure LDH phase without impurities.

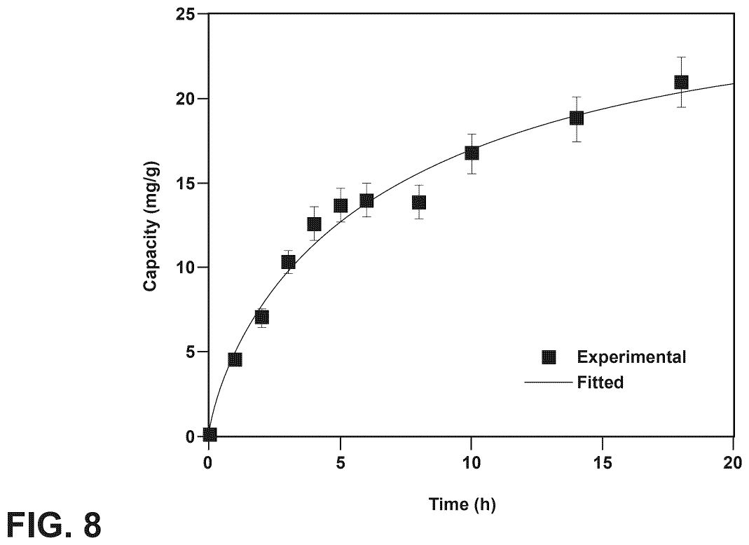

The reactivity of the amorphous Al(OH)₃ sorbent in the lithiation step was further investigated at 40° C. by kinetic experiments conducted at various reaction time periods. The results are shown in FIG. 8 summarized in Table 3 below. Lithium uptake increased progressively over time, as reflected in the decreasing concentration of lithium in the decant and the corresponding increase in loading. After 1 hour, the lithium uptake was 20.47%, with a loading of 4.54 mg/g (0.65 meq/g). This uptake increased to 47.88% after 2 hours, with a loading of 10.62 mg/g (1.53 meq/g). A notable increase was observed after 4 hours, with 60.45% uptake and a loading of 13.41 mg/g (1.93 meq/g). The lithium uptake continued to rise gradually, reaching 75.27% after 10 hours (loading of 16.70 mg/g, 2.40 meq/g) and 85.76% after 16 hours (loading of 19.03 mg/g, 2.74 meq/g). The highest uptake was observed after 18 hours, with 94.45% and a loading of 20.96 mg/g (3.02 meq/g). These results indicated a clear correlation between reaction time and lithium uptake, with significant improvements observed up to 18 hour. The ICP-OES results of the solids obtained at the various times for the kinetic experiments are shown in Table 4 below.

TABLE 3
Lithium loading and uptake percentage for Case 1 at 40 °C

| | Concentration of Li in the | % | Loading | Loading |
|---|---|---|---|---|
| Time | decant (μg/mL)* | uptake | (mg/g) | (meq/g) |
| 1 h | 1760 | 20.5 | 4.54 | 0.650 |
| 2 h | 11600 | 47.9 | 10.6 | 1.53 |
| 4 h | 878 | 60.5 | 13.4 | 1.93 |
| 6 h | 818 | 63.1 | 14.0 | 2.02 |
| 8 h | 832 | 62.5 | 13.9 | 1.99 |
| 10 h | 549 | 75.3 | 16.7 | 2.40 |
| 12 h | 553 | 75.1 | 16.7 | 2.40 |
| 14 h | 588 | 73.6 | 16.3 | 2.35 |
| 16 h | 316 | 85.8 | 19.0 | 2.74 |
| 18 h | 123 | 94.5 | 21.0 | 3.02 |

*±5% uncertainty

TABLE 4
ICP-OES Results of the Sorbate Solids
for the Kinetic Experiments.

| Time | Li (μg/g)* | Al (μg/g)* | (mg Li/g sorbent) | (meq Li/g sorbent) |
|---|---|---|---|---|
| 1 h | 7510 | 227000 | 11.5 | 1.65 |
| 2 h | 8540 | 228000 | 13.0 | 1.87 |
| 4 h | 9460 | 227000 | 14.4 | 2.07 |
| 6 h | 9660 | 226000 | 14.8 | 2.13 |
| 8 h | 9900 | 225000 | 15.2 | 2.19 |
| 10 h | 10800 | 226000 | 16.6 | 2.39 |
| 12 h | 11400 | 228000 | 17.3 | 2.49 |
| 14 h | 11700 | 226000 | 17.9 | 2.58 |
| 16 h | 12000 | 228000 | 18.2 | 2.62 |
| 18 h | 14800 | 251000 | 20.4 | 2.93 |

*±5% uncertainty

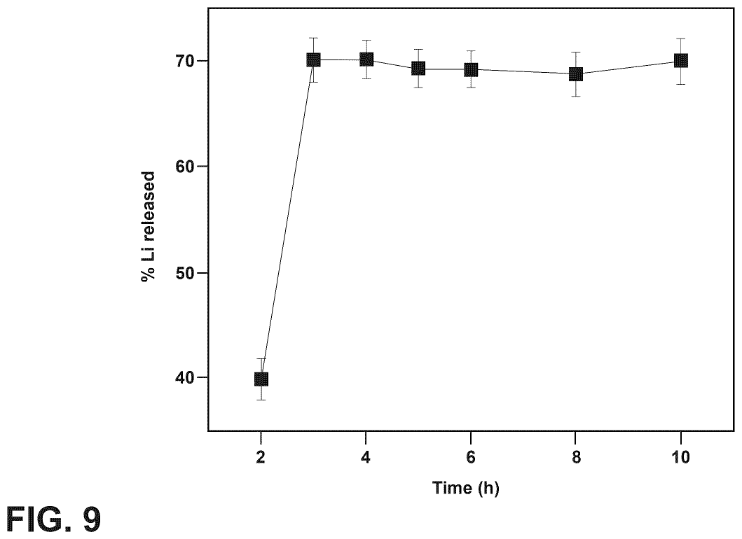

Next, kinetic experiments were conducted to evaluate the delithiation step, specifically the amount of lithium leached out of the LDH structure over time. 0.25 g of A-Cl-LDH material was added to 25 mL of distilled water in a reflux condenser with continuous stirring at 95° C. for 2 to 10 hours. Following centrifugation of the precipitate, the supernatant solution was decanted, and the solid was dried in an oven at 60° C. The results are shown in FIG. 9 as well as Table 5 below. A substantial increase in lithium release was observed within the first 3 hours, reaching a peak of 70.1% lithium release. Beyond this initial three-hour period, the lithium release rate stabilized, with only minor fluctuations observed. At 4 hours, the lithium release slightly increased to 70.2%, but then decreased to 69.4% at 5 hours, and stabilized around 69 to 70% for the subsequent time intervals. By 10 hours, the lithium release was measured at 70.0%, indicating that the delithiation process reached a saturation point after approximately 3 hours. This saturation behavior implied that the majority of lithium was released within the initial few hours, and extending the delithiation time beyond this period did not significantly enhance the release. Hence, it appears that the delithiation kinetics are rapid initially but plateau as the system approaches equilibrium, highlighting the efficiency of the process within the first few hours.

TABLE 5
Lithium Release Kinetics For Delithiation of A-Cl-LDH

| | Concentration of Li | |
|---|---|---|
| | in the decant | |
| Time | (μg/mL)* | % Li released |
| 2 h | 168 | 39.9 |
| 3 h | 196 | 70.1 |
| 4 h | 195 | 70.2 |
| 5 h | 194 | 69.4 |
| 6 h | 196 | 69.2 |
| 8 h | 197 | 68.8 |
| 10 h | 196 | 70.0 |

*±5% uncertainty

The ICP-OES results taken on the solids obtained at the various times during the delithiation step are shown in Table 6 below. The data indicated that the percentage of lithium remaining in the solid decreased significantly within the first few hours, correlating with the increased lithium release observed in the solution phase. The formation of the bayerite phase during delithiation was also observed by Scanning Electron Microscope (SEM) imaging, confirming the structural transformation of the sorbent material.

TABLE 6
ICP-OES Results of the Solids During Delithiation.

| Time | Li (μg/g)* | Al (μg/g) | % Li remaining |
|---|---|---|---|
| 2 h | 8870 | 254000 | 60.1 |
| 3 h | 4410. | 257000 | 29.9 |
| 4 h | 4390 | 252000 | 29.8 |
| 5 h | 4520 | 245000 | 30.6 |
| 6 h | 4540 | 258000 | 30.8 |
| 8 h | 4600 | 258000 | 31.2 |
| 10 h | 4420 | 250000 | 30.0 |

*±5% uncertainty

Further, addition of a second stage/cycle to the delithiation step was studied. The results, which are shown in Table 7 below, indicated that incorporation of a second stage increased the efficiency of the lithium extraction to approximately 95%.

TABLE 7
Delithiation Stages Using the Partially Delithiated
A-Cl-LDH from the First Stage in the Second Stage

| Stage | Li (μg/g)* | Al (μg/g)* | % Li remaining |
|---|---|---|---|
| 1 | 4410 | 257000 | 29.9 |
| 2 | 170 | 258000 | 3.86 |

The experiments conducted for Case 1 revealed that lithiation can be effectively achieved at temperatures as low as 40° C. Case 1 demonstrated the selective direct extraction of Li⁺ ions using A-Al(OH)₃ through a liquid-solid lithiation reaction, followed by an acid-free delithiation step. The lithiation step achieved an efficiency of approximately 95% and a maximum lithium sorption loading of around 21.0 mg/g. The sorbent exhibited high selectivity during lithiation, and nearly 70% recoverability of lithium from the sorbent material was observed during delithiation.

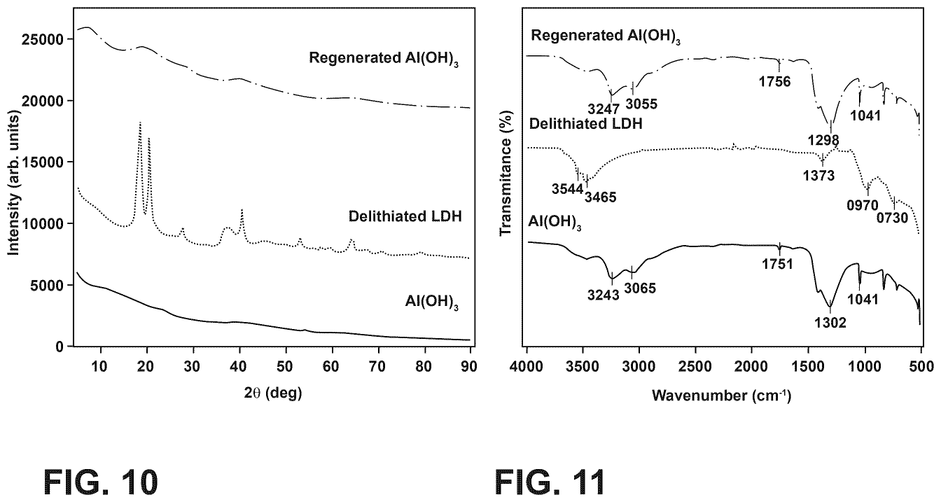

Turning next to Case 2, lithiation and delithiation experiments were conducted using the second brine-simulating solution to determine if A-Al(OH)₃ exhibited selectivity for lithium over sodium and potassium. About 5 g of A-Al(OH)₃ was added to 50 mL of the second brine-simulating solution (containing LiCl, NaCl, and KCl) and placed in a screw-capped bottle and treated at 40° C. for 18 hours. The A-Al(OH)₃ sorbent picked up ~96.2% of lithium and less than 1% Na and K as shown by the ICP-OES results in Table 8 below. The precipitated solids obtained during lithiation were separated by centrifugation and further washed 5 times with deionized water and kept for air drying at ambient temperature. The thus obtained solid A-Cl-LDH was then delithiated in two steps at 95° C. for 18 hours resulting in substantial recovery of lithium. The delithiated LDH was found to have a bayerite (B—Al(OH)₃) phase. To regenerate the sorbent and mitigate the low reactivity and performance of delithiated LDH, 2 g of delithiated LDH was dissolved in 10 mL of 8.5 M nitric acid. The pH of the solution was adjusted to 4.95 by dropwise addition of ~10 mL of ammonium hydroxide (28% V/V). The precipitate obtained was amorphous, regenerated Al(OH)₃. FIGS. 10 and 11 show PXRD patterns and Fourier Transform Infrared Spectroscopy (FTIR) spectra for the commercially-obtained (virgin) Al(OH)₃, delithiated LDH, and regenerated Al(OH)₃, confirming the transformation of delithiated LDH to amorphous Al(OH)₃ using the regeneration process. The PXRD patterns of commercial and regenerated Al(OH)₃ as seen in FIG. 10 show similar features. The regenerated Al(OH)₃ displays broad peaks at 18°, 40°, and 64° 2θ that correspond to sharp peaks in the delithiated phase. These broad peaks may suggest presence of some crystallinity in the structure. The broad and smooth absorption bands in the ranges of 400-900 and 3200-3700 cm⁻¹ in FIG. 11 correspond to the Al—O and O—H stretching vibrations. The FTIR spectra for the commercial Al(OH)₃ and the regenerated Al(OH)₃ in FIG. 11 show similar peaks validating the ability of the regeneration process. The O—H peak in the delithiated LDH phase shows a more significant shift toward higher frequency, accompanied by a decrease in intensity and higher frequency shift of the C—O stretch.

TABLE 8
ICP-OES Results for Case 2 Illustrating Li
Selectivity over Na and K for A-Al(OH)₃.

| | Concentration of | Concentration of | Concentration of | |
|---|---|---|---|---|
| | Li in the decant | Na in the decant | K in the decant | % Li |
| Experiment | (μg/mL) | (μg/mL) | (μg/mL) | pick up |
| Brine simulant | 469 | 4810 | 4470 | — |
| Lithiation (5 g) | 18.7 | 4736 | 4372 | 96.0 |

±5% uncertainty

To investigate the effectiveness of the regenerated sorbent, the regenerated Al(OH)₃ was reused as a sorbent twice using the same procedure as described above with 20 mL of the second brine-simulating solution. The regenerated Al(OH)₃ showed a lithium pickup of 45.9%. The percentage lithium pickup was lower than observed for virgin Al(OH)₃, which may be attributed to having used a lower solid to liquid ratio of 0.5 g to 20 mL compared to 2 g to 20 mL used above.

These results illustrate that lithiation can be achieved efficiently at temperatures as low as 40° C., with a lithium sorption loading reaching approximately 20.96 mg/g and an efficiency close to 95%. The sorbent used in the method displayed about 96% lithium selectivity over sodium and potassium during the lithiation process, with nearly 70% of the lithium being recoverable during delithiation, and substantial recovery achieved via a second stage.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of extracting lithium from a solution containing lithium ions, the method comprising:
mixing amorphous aluminum hydroxide (A-Al(OH)₃) with the solution at a temperature in a range of from 25 to 135° C. for a period of time, to obtain a product that includes a layered double hydroxide (LDH) including the lithium ions.

2. A method of extracting lithium from a feed solution, the method comprising:
providing a sorbent that includes amorphous aluminum hydroxide (A-Al(OH)₃);
performing a lithiation step that includes combining the sorbent with the feed solution at a first temperature for a first period of time to obtain a first mixture that includes a first sorbate, wherein the feed solution includes lithium ions;
separating the first sorbate from the first mixture; and
performing a delithiation step that includes combining the first sorbate with water at a second temperature for a second period of time to obtain a second mixture that includes a delithiated sorbate, and separating the delithiated sorbate from the second mixture to obtain a product solution that includes lithium released from the first sorbate upon treatment with water.

3. The method of claim 2, wherein the first temperature is in a range of from 25 to 135° C.

4. The method of claim 2, wherein the first temperature is in a range of from 40 to 60° C.

5. The method of claim 2, wherein the first temperature is in a range of from 25 to 60° C., and in the lithiation step the combined amorphous aluminum hydroxide and feed solution are stirred for the first period of time.

6. The method of claim 2, wherein the first temperature is in a range of from 60 to 135° C., and in the lithiation step the combined amorphous aluminum hydroxide and feed solution are mixed in a reflux condenser or autoclave for the first period of time.

7. The method of claim 2, wherein the first period of time is in a range of from 5 minutes to 18 hours.

8. The method of claim 2, wherein the first sorbate includes a layered double hydroxide (LDH), the layered double hydroxide including Al³⁺ and Li⁺ cations and further including anions from the feed solution.

9. The method of claim 2, wherein the second temperature is in a range of from 92 to 98° C.

10. The method of claim 2, wherein the second period of time is in a range of from 2 to 10 hours.

11. The method of claim 2, wherein the second period of time is in a range of from 2 to 4 hours.

12. The method of claim 2, wherein a ratio of sorbent to feed solution in the lithiation step is approximately 1 g to 10 mL.

13. The method of claim 2, wherein a lithium capacity of the lithiation step is at least 10 mg lithium per 1 g sorbent.

14. The method of claim 13, wherein the lithium capacity is at least 20 mg/g.

15. The method of claim 2, wherein: i) the lithiation step is performed in either a single stage or a plurality of stages; and ii) the delithiation step is performed in either a single stage or a plurality of stages.

16. The method of claim 15, wherein: i) the lithiation step is performed in two or more stages, and a sorbent stream and a feed solution stream are arranged in cross-flow or counter-current flow; ii) the delithiation step is performed in two or more stages, and a sorbate stream and a water stream are arranged in cross-flow or counter-current flow; or iii) both i) and ii).

17. The method of claim 2, further comprising a sorbent regeneration step including dissolving the delithiated sorbate in nitric acid to obtain a regeneration mixture, and adding sodium hydroxide and ammonium hydroxide to the regeneration mixture at a pH of approximately 6 or less to form amorphous aluminum hydroxide.

18. The method of claim 2, wherein the feed solution includes at least one of chloride ions, sulfate ions, nitrate ions, carbonate ions, and hydroxide ions.

19. The method of claim 2, wherein the feed solution is obtained from: i) recycled lithium-ion battery material; ii) a source of raw minerals; iii) mine tailings; or iv) a chemical process/oil and gas drilling stream.

20. The method of claim 2, wherein the feed solution is a brine.
